(19) United States
(12) Patent Application Publication
(10) Pub. No.: US 2004/0139332 A1
(43) Pub. Date: Jul. 15, 2004

(54) Portable biodata protected data storage unit

(76) Inventor: Boon Lum Lim, Singapore (SG)

Correspondence Address: CLARK & BRODY, Suite 600, 1750 K Street, NW, Washington, DC, 20006, US

(21) Appl. No.: 10/615,137

(22) Filed: Jul. 9, 2003

(30) Foreign Application Priority Data
Jul. 12, 2002 (GB) 0215971 3

(51) Int. Cl. H04L 9/32

(52) U.S. Cl. 713/185

(57) ABSTRACT

A portable data storage device includes a biometrics recognising apparatus which comprises a biometric sensor and a biometrics processing engine. The storage device further includes a memory storage facility, a micro controller and a communications interface to enable the storage device to communicate with a host computer, an access control unit, a bioparameters storage unit, a combination encryption key generation means, a device code generation means, a bioencryption engine for encryption and decryption and a data processing unit.

### FIELD OF INVENTION

This invention relates to a portable data storage unit which is capable of storing and easily transporting large amounts of data and which is disposed with a biometrics protected security and encryption function such that access to the data stored in the device is secured and available only to authorised users who provide the required biometric parameters.

### BACKGROUND

Biometrics parameters which may be utilised to secure access to data stored in the device include personal bio-behaviour or bio-characteristics such as fingerprint minutiae, voice characteristics, iris recognition, facial features and the like.

At this time there are no storage devices which are able to utilise a very broad range of biometrics parameters to secure access to data held in memory. This invention defines a complete bio protected portable data storage methodology which can utilise biometrics parameters such as finger print minutiae, voice vocal trace, eye iris, facial features and the like. Further there are no data storage devices which utilise the encryption methodology of generating an encryption key based on individual biometric parameters and a factory preset pointer to secure data. The use of such polynomial encryption appending function provides a degree of security which is not available with known data storage devices.

### SUMMARY OF THE INVENTION

A portable data storage device includes a biometrics recognising apparatus which comprises a biometric sensor and a biometrics processing engine. The storage device further includes a memory storage facility, a micro controller and a communications interface to enable the storage device to communicate with a host computer, an access control unit, a bioparameters storage unit, a combination encryption key generation means, a device code generation means, a bioencryption engine for encryption and decryption and a data processing unit.

The biometrics recognising apparatus is able to acquire the necessary biometric parameters from users and store the same in a storage means disposed within the device and which information can be used to permit access to the data stored in the storage means to authorised users only.

The biometrics sensor is reversibly connected to the biometrics processing engine. The biometrics processing engine is interconnected with an access control decision unit and a bioparameters storage unit. The bioparameters storage unit and the biometric processing engine are also interconnected with a combination encryption key generation means which is itself connected with a device code generation means. The access control unit is interconnected with a micro controller and a bioencryption engine unit which is itself interconnected with the memory storage means. The bioencryption engine is also reversibly interconnected with a data processing unit which is itself connected to the micro controller. The micro controller is reversibly connected to the communications device and thus to a host computer.

The biometrics sensor and biometrics processing engine are capable of receiving, recognising, processing, identifying and verifying the desired biometric parameters from end users.

The device enables data to be transferred between a host computer and the storage device by a standard communications port employing standard data transfer protocols such as USB, UART, PCMCIA, Compact Flash, Fire-Wire and the like. The communications interface provides a channel between a host computer and the portable storage device which enables data to be sent to and retrieved from the device.

The biometrics processing engine comprises a processor capable of processing a digital signal and which engine is able to perform computations and calculations based on a set of predefined algorithms to generate a reference database in respect of the biometrics parameters.

The biometrics sensor comprises a sensing apparatus capable of receiving and recognising a variety of biometric data from a user such as fingerprint data, voice data, iris data, facial data or the like. The sensing apparatus may be active or passive and may incorporate one or more of optical, capacitive, electric field, laser, infra red or magnetic technology.

The biometrics sensor acquires the desired biometrics parameters from the user and these parameters are processed by the biometric processing engine in accordance with predefined algorithms and generate a reference database in respect of the said biometric data, which may be stored in the storage means.

Users biometric parameters are stored in the bioparameters storage unit pending encryption. The biometric parameters are encrypted by the bioencryption engine using the biometric parameters and a factory preset parameter.

The storage means which may be volatile or non-volatile is capable of reversibly receiving and storing data for multi read/write applications.

The micro controller comprises a processor which incorporates the communications interface protocol and provides a gateway for data to be stored and retrieved from the storage means. The micro controller may also be disposed with a bioencryption algorithm. The bioencryption processing is based on the users biometrics information and this encrypted information acts as key to permit access to the data. The encryption process makes use of two parameters namely a factory preset parameter and the individual biometric parameter input by the user to create an encryption key for the encryption process. Such encryption key will be pointed and accessible by a pointer called the encryption pointer. Both the encryption and decryption pointers are the same and they complement each other.

Access can also be further secured with device identification to provide both bioencryption and system protection.

Data input by a user can be secured in accordance with the chosen biometric parameters and thus access to the stored data is limited only to those users who are enrolled as authorised users.

Enrollment of biometric data is carried out in respect of each authorised user. Each such user presents his/her required biometrics parameters to the biometrics sensor disposed in the device. The said biometric parameters are scanned and processed by the biometrics processing engine in accordance with predefined encryption algorithms. The scanning and identification process may be repeated to ensure accuracy in recognition of the biometric parameter. The encrypted biometric parameter is then stored in the storage means and must be represented to the scanner to enable access to the data. The bioencryption is based on the users biometric information as the basic encryption key and in combination with device identification provides data and system protection. The further advantage of such encryption is that it is not possible to manually open the device, remove the storage means and gain access to the data via other commercial readers.

### BRIEF DESCRIPTION OF THE DRAWINGS

The invention will now be described by reference to the figures.

FIG. 1 is a system functional block diagram and operational flowchart.

FIG. 2 is a functional flow chart of proprietary data bioencryption scheme.

### DESCRIPTION OF THE PREFERRED EMBODIMENTS

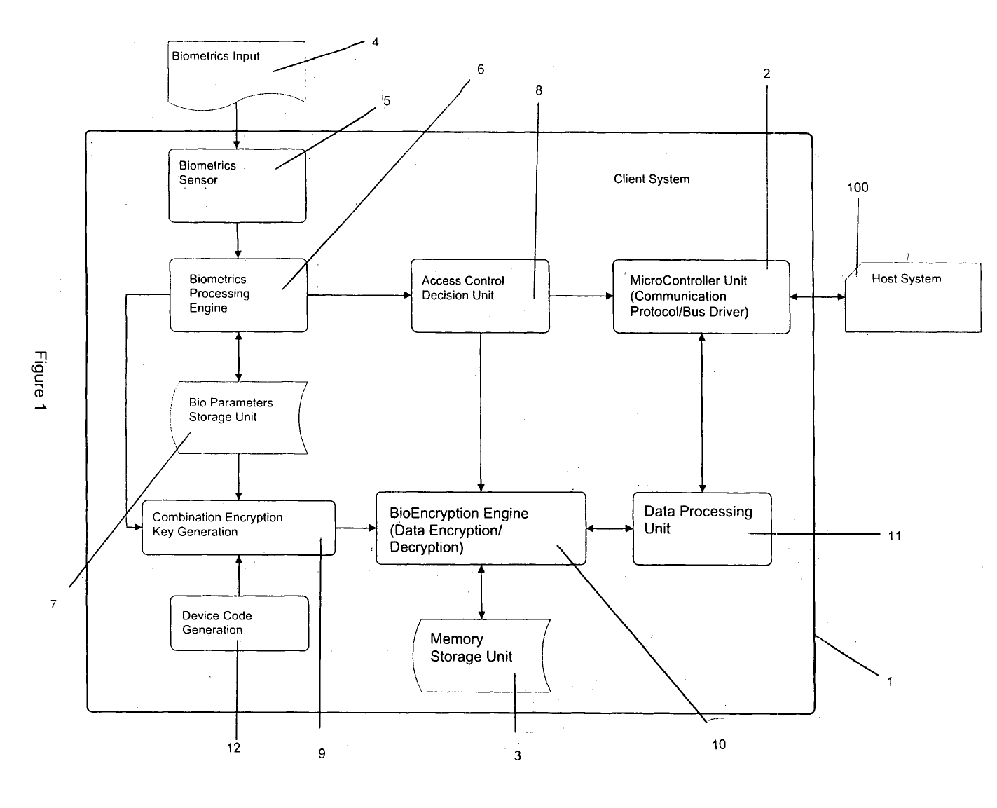

FIG. 1 shows the relationship of the various components of the data storage device and the operational flowchart interconnecting the components. The device (1) may be connected to a host computer (100) via a communications interface (2). Data from the device can be uploaded to and downloaded from host computer through the communications interface (2). Data is stored in the storage means (3) and access to this data requires the correct biometric input from the biometrics scanner (4). The desired biometrics parameters are presented to the biometrics scanner which reads the said data. This data is then processed by the biometrics processing engine (6) which is in connection with the biometrics sensor (5), the biometrics parameters storage unit (7) and the access control decision unit (8).

The access control decision unit evaluates the data processed by the biometrics engine and decides whether to grant access to the data stored in the memory means within the device. Such decision will be based on the degree and accuracy of the match between the input biometrics information and the biometrics template and parameters stored within the device.

If access right is granted, an encryption pointer will be generated for the encryption or decryption of the data information depending on whether it is a write or read process respectively.

The biometrics parameters storage unit (7) is interlinked to an encryption key generator (9) which is in turn interlinked to the bioencryption engine which encrypts and decrypts the data. Encrypted biometric data is then stored in the memory means (3).

In practice the user would enroll his/her biometric data by presenting such data to the biometric scanner (4). The biometric sensor (5) would read the data and transfer the data to the biometrics processing engine.

The data is then encrypted by the bioencryption engine processing the data in accordance with the encryption key generated by the device code generation means (12). The encrypted biometric data is then stored in the memory means (3).

The encryption process makes use of two parameters namely a factory preset parameter and the individual biometric parameter input by the user to create an encryption key for the encryption process. Such encryption key will be pointed and accessible by a pointer called the encryption pointer. Both the encryption and decryption pointers are the same and complement each other.

Access to data stored in the device would require the user to present his/her biometric data to the scanner (4). The scanner reads the biodata presented. The said biodata is then analysed by the access control decision unit (8). The access control decision unit evaluates the data to establish whether the biodata is in conformity with the enrolled biodata stored in the memory means. If the biodata is acceptable the bioencryption engine (10) generates a decryption key to allow the user access to the data. Data can then be accessed through the communications interface (2) via the host computer (100).

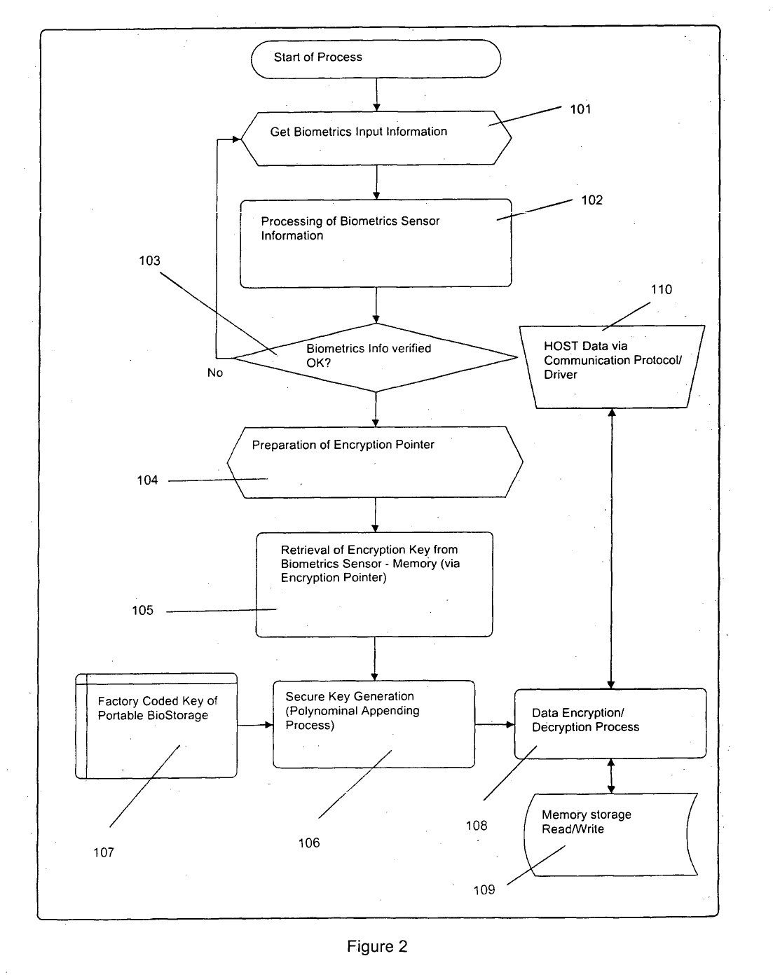

FIG. 2 sets out the functional flow chart of biodata encryption scheme. At the start of the process biometric information is input into the device via the scanner (101). This information is processed by the biometric sensor (102). The data is then verified (103) by the biometric processing engine. If the data is not verified further biometric data may be requested. If however the biometric data is verified the encryption key generation means prepares an encryption pointer (104). The encryption process makes use of two parameters namely a factory preset parameter (107) and the individual biometric parameter input by the user to create an encryption key for the encryption process. Such encryption key will be pointed and accessible by a pointer called the encryption pointer. Both the encryption and decryption pointers are the same and they complement each other.

The encryption key, in respect of the presented biodata, which is stored in the memory means (105) is then retrieved. The encryption key is then added to the biodata (106) and the biodata is then decrypted (108) by the bioencryption engine.

Successful decryption enables the user to access data stored in the memory means (109) of the device via the communications interface (110).

1. A portable data storage device which can interface with a remote computer such as a desktop PC or a portable notebook computer and which is capable of securely storing data in digital format by reference to one or more biometric parameters and wherein such biometric parameters are encrypted by reference to a bioencryption algorithm stored within the device and wherein device is disposed with a biometric sensor, a biometric processing engine, a memory storage facility, a micro-controller, a communications interface, an access decision control unit, a bioparameter storage unit, a combination encryption key generation means, a device code generation means, a data processing unit and a bioencryption engine.

2. A device as claimed in claim 1 wherein the biometric sensor is connected to the biometrics processing engine.

3. A device as claimed in claim 1 wherein the biometric processing engine is connected to an access control decision unit and a bioparameters storage unit.

4 A device as claimed in claim 1 wherein the bioparameters storage unit and the biometric processing engine are further connected with a combination encryption key generation means.

5. A device as claimed in claim 1 wherein the combination encryption key generation means is connected with a device code generation means.

6. A device as claimed in claim 1 wherein the access control unit is connected to the micro-controller and a bioencryption engine.

7. A device as claimed in claim 1 wherein the bioencryption engine is connected to the memory storage means and is reversibly connected with a data processing unit.

8. A device as claimed in claim 1 wherein the data processing unit is connected to the micro-controller.

9. A device as claimed in claim 1 wherein the micro-controller is reversibly connected to the communications interface.

10. A device as claimed in claim 1 wherein the biometric sensor may receive biometric parameters from users and wherein the sensor may be active or passive.

11. A biometric sensor as claimed in claim 10 wherein the sensor may incorporate one or more optical, capacitive, electric field, laser, infra red and or magnetic sensor and wherein the biometric sensor can scan and receive biometric parameters from users.

12. A biometric processing engine as claimed in claim 1 wherein the engine comprises a processor capable of processing digital input from the sensor in accordance with predefined bioprocessing algorithms and wherein such bioprocessed data with encryption can be stored in the memory means.

13. A memory storage means as claimed in claim 1 wherein the storage means may be volatile or non-volatile and wherein the storage means is capable of reversibly receiving and storing data for multi read/write applications.

14. A bioparameters storage unit as claimed in claim 1 wherein bioparameters received from users are stored pending approval of the bioparameters prior to access to the data in the memory storage means.

15. A combination encryption key generation means as claimed in claim 1 wherein the user bio-input key which is generated from the biometrics algorithm based on the user biometric parameter input and a predefined key are combined to generate a new key for encryption of the biodata.

16. A device code generation means as claimed in claim 1 wherein factory preset parameters are stored.

17. An access control decision unit as claimed in claim 1 wherein the access control decision unit evaluates biodata received by the sensor and processed by the biometric processing engine to permit or deny access to the data stored in the memory means.

18. A bioencryption engine as claimed in claim 1 wherein bioparameters from users and factory preset parameters from the device code generator are encrypted and decrypted in accordance with predefined algorithms.

19. A data processing unit as claimed in claim 1 wherein data stored in the memory means is processed prior to access by a user via a communications interface.

20. A micro-controller as claimed in claim 1 which comprises a processor which incorporates a communications interface whereby a user may interface the data storage device via a host computer.

21. A micro-controller as claimed in claim 20 wherein the micro-controller is disposed with a bioencryption algorithm.

22. A process of encryption of biometric parameters wherein biometric data from users is presented to the biometrics sensor and wherein the biometric sensor reads and transfers the biometric data to the biometric processing engine and wherein the biometric parameter is encrypted by the bioencryption engine by reference to the biometric data and a factory preset parameter in accordance with predefined algorithms in a polynominal process to produce an encryption key and wherein the encrypted biometric data is stored in the memory means.

23. A process of decryption of biometric parameters presented to the biometric sensor by a user wherein the data presented to the biometric sensor is read by the sensor and wherein the said data is then analysed by the access control decision unit in accordance with predefined parameters to ascertain whether the said biodata is in conformity with the enrolled biodata and wherein the bioencryption engine then generates a decryption key in respect of biodata verified by the access control decision unit and wherein the decryption key permits access to the data stored in the memory means.
